(19) United States
(12) Patent Application Publication
(10) Pub. No.: US 2013/0251171 A1
(43) Pub. Date: Sep. 26, 2013

(54) PORTABLE CHARGER FOR A BLUE-TOOTH HEADSET

(71) Applicant: HUNG-CHANG LIU, New Taipei City (TW)

(72) Inventor: HUNG-CHANG LIU, New Taipei City (TW)

(21) Appl. No.: 13/427,460

(22) Filed: Mar. 22, 2012

(51) Int. Cl. H02J 7/00; H04R 1/10

(52) U.S. Cl. 381/74

(57) ABSTRACT

A portable charger for a blue-tooth headset has a body, a power input port, a power storage module, a space, an open hole, and a charging port. The power input port is formed on the body. The power storage module is mounted inside the body and electrically connected to the power input port. The space is formed inside the body. The open hole is formed through one side of the body and communicates with the space. The charging port is mounted on one side defining the space. When a battery of the blue-tooth headset is dead, users can place the blue-tooth headset inside the space. The blue-tooth headset is electrically connected to the charging port for charging the blue-tooth headset. The users can easily carry around the portable charger and the blue-tooth headset that is being charged.

### BACKGROUND OF THE INVENTION

1. Field of the Invention

This invention relates to a portable charger, especially to a portable charger which can charge a blue-tooth headset inside the portable charger.

2. Description of Related Art

Mobile phones are very popular and convenient, but an issue is that using the mobile phones at driving causes many car accidents. The issue can be solved by using a blue-tooth headset at driving. The blue-tooth headset is a wireless headset communicating to a mobile phone by blue-tooth communication protocols. Drivers can use the blue-tooth headset to avoid holding a mobile phone by hand for calling.

A conventional blue-tooth headset cannot sustain for a long time without charging. For resolving the car accident issue, users need to use the blue-tooth headset for a long time. The blue-tooth headset needs much power to keep on communicating with the mobile phone anytime. Therefore, the users always need to bring a charger for charging the blue-tooth headset, and look for a mains power socket. When the users go out, a mains power socket is not easily found for charging the blue-tooth headset, and users have to wait for charging the blue-tooth headset nearby the socket until the charging is finished. This charging issue is inconvenient to the users who stay out of doors.

### SUMMARY OF THE INVENTION

This invention provides a portable charger for a blue-tooth headset. Users can place a blue-tooth headset inside the portable charger for charging without waiting nearby a mains power socket.

The portable charger includes a body, a power input port, a power storage module, a space, an open hole, and a charging port. The power input port is formed on the body. The power storage module is mounted inside the body and electrically connected to the power input port for storing a charging power that is converted from a mains power. The space is formed inside the body for placing the blue-tooth headset. The open hole is formed through one side of the body and communicating with the space. The charging port is mounted on one side defining the space and electrically connected to the power storage module and the blue-tooth headset for transmitting the charging power from the power storage module to the blue-tooth headset. When a battery of the blue-tooth headset is dead, users can place the blue-tooth headset inside the space. The blue-tooth headset is electrically connected to the charging port for charging the blue-tooth headset. The users can easily carry around the portable charger and the blue-tooth headset that is being charged.

### BRIEF DESCRIPTION OF THE DRAWINGS

FIG. 1 is a perspective view of a first embodiment of this invention;

FIG. 2 is a block diagram of a charging path of a blue-tooth headset of this invention;

FIG. 3 is a perspective view of a second embodiment of this invention;

FIG. 4 is a perspective view of a third embodiment of this invention;

FIG. 5 is a perspective view of a fourth embodiment of this invention;

FIG. 6 is an operational view of a fourth embodiment when charging a blue-tooth headset; and

FIG. 7 is an operational view of a fourth embodiment when charging a mobile phone.

### DETAILED DESCRIPTION OF PREFERRED EMBODIMENT

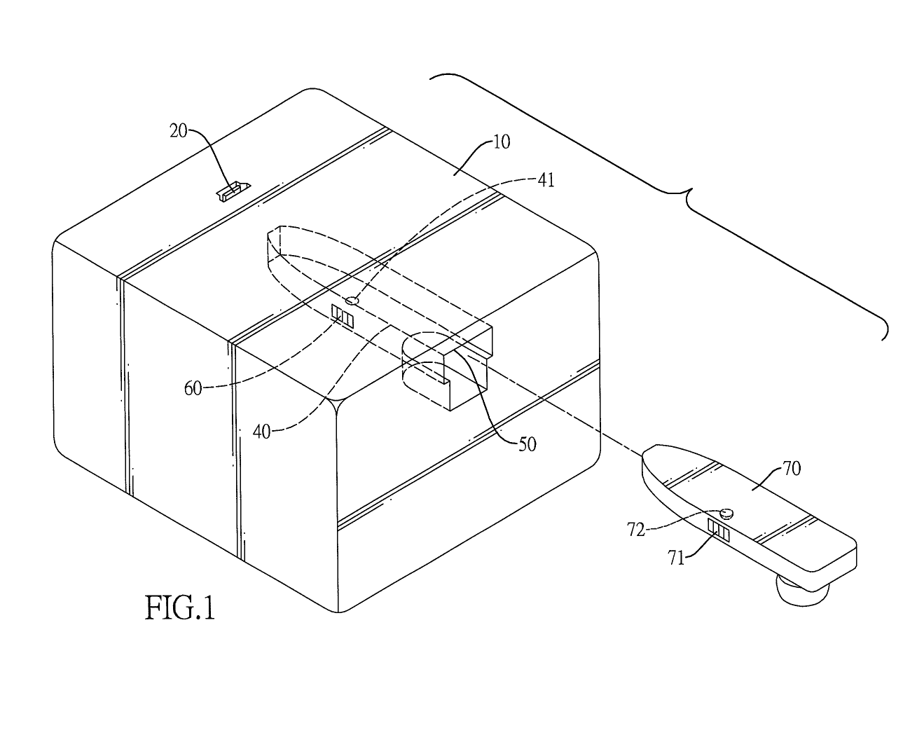

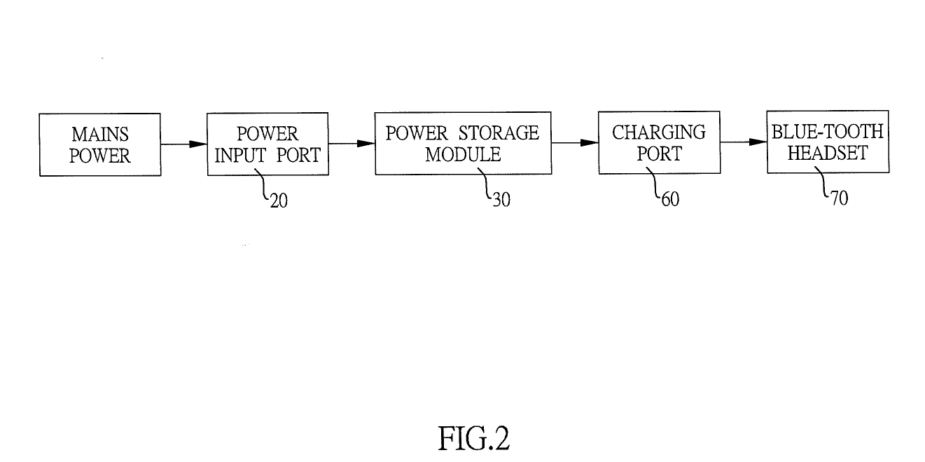

FIGS. 1 and 2 are a first embodiment of a portable charger for a blue-tooth headset. The portable charger comprises a body 10, a power input port 20, a power storage module 30, a space 40, an open hole 50, a first charging port 60, and a positioning assembly.

The power input port 20 is formed on the body 10 for receiving an input power. In this embodiment, the power input port 20 is a mini universal serial bus (mini-USB) port. The mini-USB port can receive the input power converted from a mains power.

The power storage module 30 is mounted inside the body 10 and electrically connected to the power input port 20. The input received from the power input port 20 is converted to a charging power for charging the blue-tooth headset 70 by the power storage module 30. The charging power is stored by the power storage module 30.

The space 40 is formed inside the body 10, and matches a shape of a first blue-tooth headset 70 for placing the first blue-tooth headset 70 inside.

The open hole 50 is formed through one side of the body 10 and communicates with the space 40. The first blue-tooth headset 70 can be placed inside the space 40 through the open hole 50.

The first charging port 60 is mounted on one side of the space 40. The first charging port 60 is electrically connected to the first blue-tooth headset 70 placed inside the space 40. The first charging port 60 is also electrically connected to the power storage module 30. The connected first blue-tooth headset 70 is charged by the charging power from the power storage module 30 through the first charging port 60. A position of the first charging port 60 and a type of the first charging port 60 correspond to the first blue-tooth headset 70.

For example, in this embodiment, a first connecting port 71 for charging the first blue-tooth headset 70 is a conductive sheet and is mounted on one side of the first blue-tooth headset 70. The first charging port 60 is also a conductive sheet, and is mounted on a side defining the space 40. The first connecting port 71 of the first blue-tooth headset 70 is electrically connected to the first charging port 60 corresponding to the first connecting port 71. The type of the first charging port 60 can be a plug such as a mini-USB plug.

With reference to FIG. 1, both the first connecting port 71 and the first charging port 60 are a conductive sheet type, so the first blue-tooth headset 70 is not easily positioned inside the space 40 for connecting the first charging port 60. Therefore, a positioning element, such as a first protrusion 72, is formed on a bottom of the first blue-tooth headset 70.

In this embodiment, the positioning assembly is formed on a side defining the space 40, so the first blue-tooth headset 70 can be positioned inside the space 40. The positioning assembly is a first cavity 41. The first cavity 41 is formed on a bottom surface defining the space 40, and corresponds to the first protrusion 72 of the first blue-tooth headset 70.

After users charge the power storage module 30 of the portable charger by connecting the power input port 20 to the mains power, the portable charger can be carried around by the users. When a battery of the blue-tooth headset is dead, the users can place the first blue-tooth headset 70 inside the space 40. The first connecting port 71 of the first blue-tooth headset 70 is electrically connected to the first charging port 60 for charging the first blue-tooth headset 70. Therefore, the users do not have to wait for charging the first blue-tooth headset 70 nearby a power socket of the mains power like using a conventional blue-tooth headset charger.

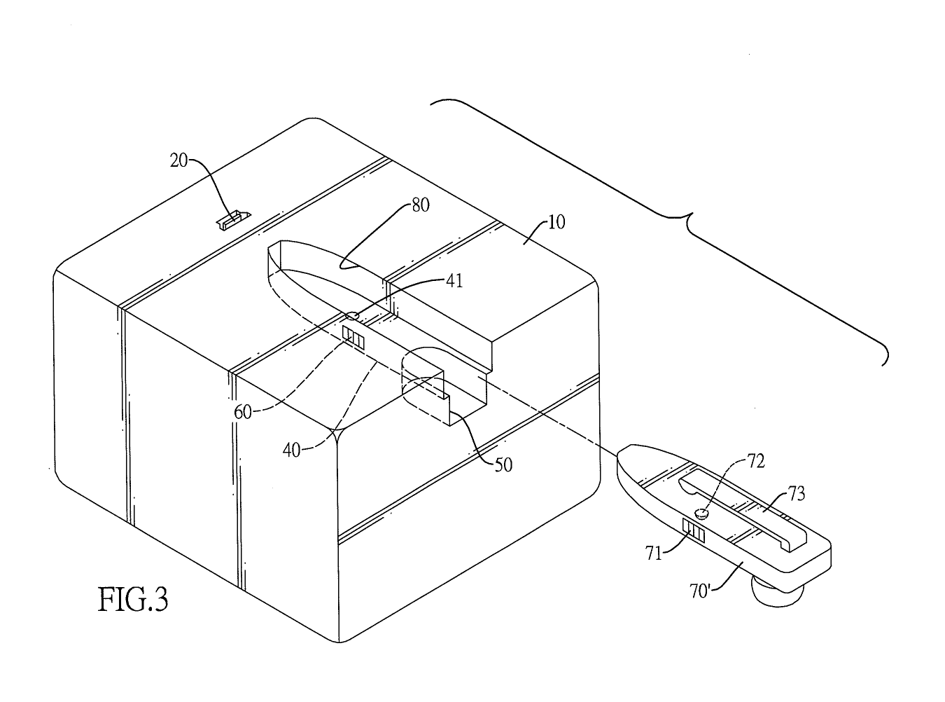

FIG. 3 is a second embodiment of this invention. This embodiment is applied in a second blue-tooth headset 70′. A back clip 73 is formed on a top surface of the second blue-tooth headset 70′. The second embodiment of the body 10 is similar to the first embodiment of the body 10. The second embodiment of the body 10 further has a window 80. The window 80 is formed through one side of the body 10, and communicates with the open hole 50 and the space 40. When the second blue-tooth headset 70′ is placed into the space 40, the back clip 73 of the second blue-tooth headset 70′ is exposed outside the body 10 through the window 80, so the second blue-tooth headset 70′ with the back clip 73 can be placed into the space 40.

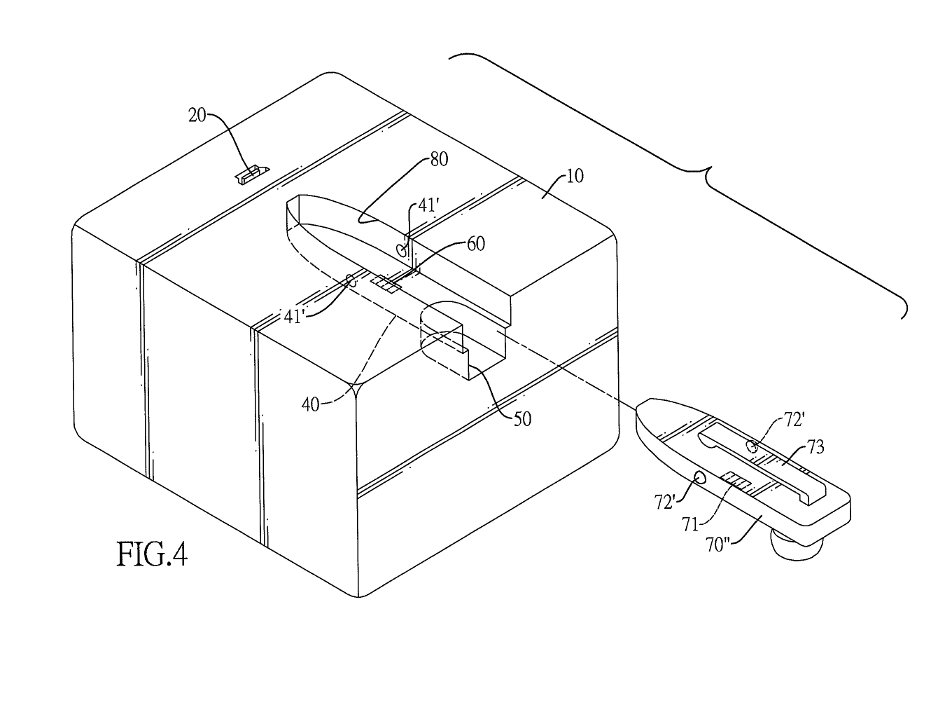

FIG. 4 is a third embodiment of this invention. This embodiment is applied in a third blue-tooth headset 70″. The third blue-tooth headset 70″ has the first connecting port 71, two second protrusions 72′, and the back clip 73. The first connecting port 71 is mounted on a bottom surface of the third blue-tooth headset 70″. The two second protrusions 72′ are respectively formed on two sides of the third blue-tooth headset 70″. The third embodiment of the body 10 is similar to the second embodiment of the body 10. In the third embodiment, the first charging port 60 is a type of a conductive sheet, and is mounted on a bottom surface of the space 40. The positioning assembly has two second cavities 41′. The two second cavities 41′ are respectively formed on two opposite sides defining the space 40, and correspond to the two second protrusions 72′.

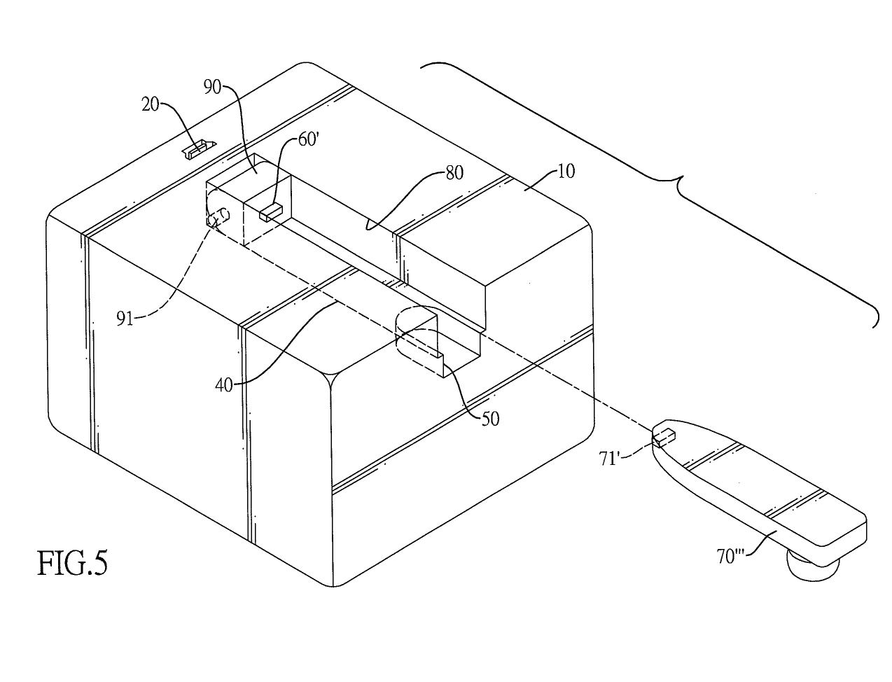

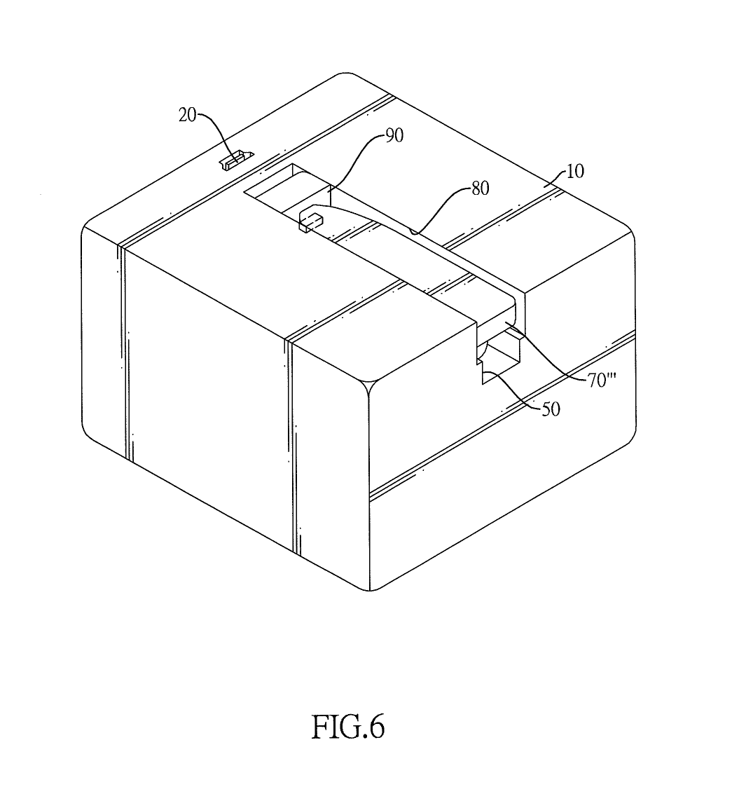

The fourth embodiment of this invention is applied in a fourth blue-tooth headset 70′″ as shown in FIGS. 5 and 6. The fourth blue-tooth headset 70′″ can have the back clip 73 as the second embodiment or the third embodiment, or can be without the back clip 73 as the first embodiment. A second connecting port 71′ is formed on a front end of the fourth blue-tooth headset 70′″. The second connecting port 71′ is a connector, such as a mini-USB port. The fourth embodiment of the body 10 is similar to the second embodiment of the body 10 and the third embodiment of body 10. The fourth embodiment of the body 10 further has a rotating component 90. The fourth blue-tooth headset 70′″ can be positioned by the connector of the connecting port 71′.

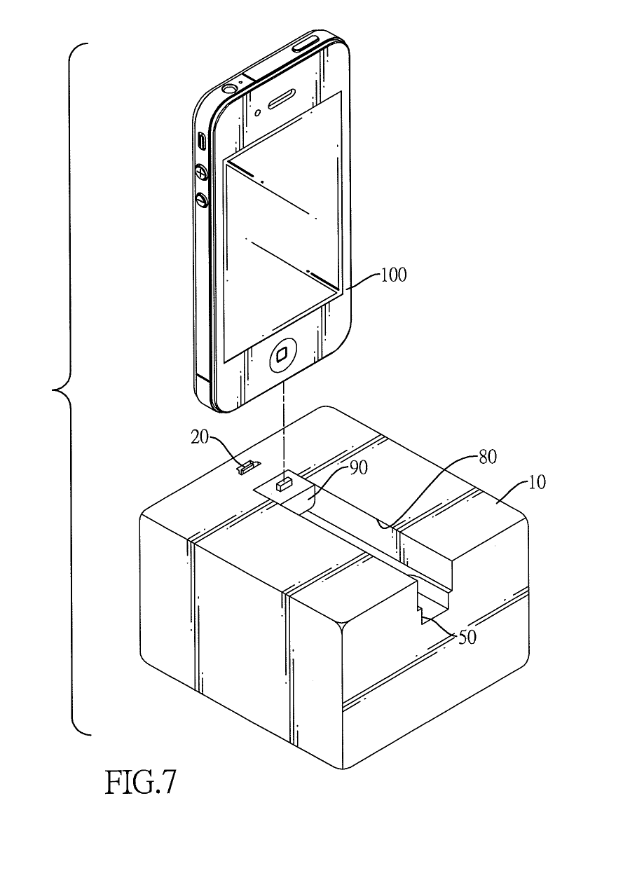

The rotating component 90 is placed on an end surface defining the space 40. The end surface is opposite to the open hole 50. A pivot 91 is formed through the rotating component 90. Two ends of the pivot 91 are mounted in two opposite sides defining the space 40. The rotating component 90 is rotatable toward outside the window 80. A second charging port 60′ is formed on the rotating component 90 and is rotated with the rotating component 90 toward inside the space 40 or outside the window 80. The second charging port 60′ matches the second connecting port 71′ of the third blue-tooth headset 70″, such as a mini-USB plug and a mini-USB socket. When the second charging port 60′ of the rotating component 90 is rotated toward outside the window 80, a top end of the rotating component 90 and a top surface of the body 10 are on the same plane. In this situation, the third blue-tooth headset 70″ can be charged and stood on the body 10. With reference to FIG. 7, if an electronic device 100 fits a specification of the portable charger, the electronic device 100 can be electrically connected to the second charging port 60′ by standing connection or a connecting cable, so the electronic device 100 can be charged by the portable charger of this invention.

What is claimed is:

1. A portable charger for a blue-tooth headset comprising:
a body;
a power input port formed on the body for receiving an input power converted from a mains power;
a power storage module mounted inside the body and electrically connected to the power input port to convert the input power to a charging power;
a space formed inside the body for placing a blue-tooth headset;
an open hole formed through one side of the body and communicating with the space; and
a charging port mounted on one side defining the space and electrically connected to the power storage module for transmitting the charging power from the power storage module to the blue-tooth headset.

2. The portable charger as claimed in claim 1, wherein the portable charger comprises a window formed through one side of the body, and communicating with the open hole and the space.

3. The portable charger as claimed in claim 2, wherein the portable charger comprises
a rotating component placed on an end surface defining the space, and being rotatable toward outside the window; the rotating component having a pivot formed through the rotating component and mounted in two opposite sides defining the space;
the charging port being a connecting plug and formed on the rotating component;
when the charging port is rotated toward outside the window, a top end of the rotating component and a top surface of the body being on the same plane.

4. The portable charger as claimed in claim 1, wherein the charging port is a conductive sheet.

5. The portable charger as claimed in claim 2, wherein the charging port is a conductive sheet.

6. The portable charger as claimed in claim 1, wherein the portable charger comprises a positioning assembly formed on a side defining the space for positioning the blue-tooth headset.

7. The portable charger as claimed in claim 2, wherein the portable charger comprises a positioning assembly formed on a side defining the space for positioning the blue-tooth headset.

8. The portable charger as claimed in claim 3, wherein the portable charger comprises a positioning assembly formed on a side defining the space for positioning the blue-tooth headset.

9. The portable charger as claimed in claim 4, wherein the portable charger comprises a positioning assembly formed on a side defining the space for positioning the blue-tooth headset.

10. The portable charger as claimed in claim 5, wherein the portable charger comprises a positioning assembly formed on a side defining the space for positioning the blue-tooth headset.

11. The portable charger as claimed in claim 6, wherein the positioning assembly comprises a cavity formed on a bottom surface defining the space.

12. The portable charger as claimed in claim 7, wherein the positioning assembly comprises a cavity formed on a bottom surface defining the space.

13. The portable charger as claimed in claim 8, wherein the positioning assembly comprises a cavity formed on a bottom surface defining the space.

14. The portable charger as claimed in claim 9, wherein the positioning assembly comprises a cavity formed on a bottom surface defining the space.

15. The portable charger as claimed in claim 10, wherein the positioning assembly comprises a cavity formed on a bottom surface defining the space.

16. The portable charger as claimed in claim 6, wherein the positioning assembly comprises multiple cavities respectively formed on two opposite sides defining the space.

17. The portable charger as claimed in claim 7, wherein the positioning assembly comprises multiple cavities respectively formed on two opposite sides defining the space.

18. The portable charger as claimed in claim 8, wherein the positioning assembly comprises multiple cavities respectively formed on two opposite sides defining the space.

19. The portable charger as claimed in claim 9, wherein the positioning assembly comprises multiple cavities respectively formed on two opposite sides defining the space.

20. The portable charger as claimed in claim 10, wherein the positioning assembly comprises multiple cavities respectively formed on two opposite sides defining the space.
